(19) United States
(12) Patent Application Publication
(10) Pub. No.: US 2009/0002163 A1
(43) Pub. Date: Jan. 1, 2009

(54) SYSTEM AND METHOD FOR IMPROVING RFID TAG READING PERFORMANCE

(76) Inventors: Carl Coleman Farrington, Berkeley, CA (US); Bradley Alan Fullmer, Albany, CA (US); Adrian Sean Klerman, Berkeley, CA (US)

Correspondence Address: NURI DAGDEVIREN, 140 SUGAR LOAF DR., TIBURON, CA, 94920, US

(21) Appl. No.: 11/754,072

(22) Filed: May 25, 2007

(51) Int. Cl. G08B 13/14

(52) U.S. Cl. 340/572.1

(57) ABSTRACT

A system and a method for improving the reading range of RFID tags and detecting objects without placing RFID tags on them, through placement of the tags in optimal positions with respect to other elements responsive to electromagnetic waves that are naturally present in the environment of use of the RFID tags. RFID tags are placed in optimal positions with respect to metal surfaces on an object to be detected to enhance their readability based on reflective contributions of the RFID signal from the metal surfaces. Detection of objects possessing metal surfaces without RFID tags placed on them are achieved by placing an RFID tag behind a reader in a reader assembly and relying on the RF energy reflected from the metal surface of the object.

### BACKGROUND OF THE INVENTION

This application discloses an invention that is related, generally and in various embodiments, to systems and methods for improving read performance of RFID tags using standard antennas. The disclosed invention may be utilized to improve overall performance of RFID tag detection based systems.

RFID tag based systems allow tracking of objects based on unique identification of the RFID tag placed on the object by the reader which typically forwards the RFID information to a more central resource that holds a table of relevant RFID list such that the identification of the RFID can be correlated with the identification of an object that is meaningful and useful in the context of the operation.

Passive RFID systems typically work by transmitting RF energy in a general direction from or near the reader, the passive RFID tag located in that general direction being stimulated by the presence of this RF energy, using the received RF signal to derive electrical energy and to transmit back a signal reflecting the ID of the passive tag and eventual detection of this signal by the reader. In active RFID systems, the tag itself is powered to generate the ID signal transmitted from the tag. Often, it may not be practical to place the tag and the reader in close proximity or in good alignment by design. Therefore, the overall performance of the RFID based systems depends on the ability of the reader to identify the tag under difficult circumstances when the tag may be far in distance from the reader or obstructed in view of the reader.

Designers of the RFID tags and readers have already made numerous improvements to the read performance of the reader-tag combinations by carefully designing the reader antennas for optimum gain and tag geometry for optimum reflectivity. The present invention improves upon the state of the art performance of the reader—tag combination by further improving the tag readibility through optimal packaging and placement of the tag on the object to be identified.

### SUMMARY

In one general respect, this application discloses a system for improving the performance of RFID based identification systems. According to various embodiments, the system includes an RFID tag package design and placement methods to improve the detection performance of RFID tags. The RFID tag package is configured for attachment to objects desired to be identified and tracked. The RFID reading device can then detect and identify these improved tags over longer distances or when they are obstructed.

The improved package design takes into account the electromagnetic characteristic of the packaging material as well as that of the object onto which the tag package is affixed. In this way, any potentially detrimental effects of the packaging material interference from the detected object are eliminated in favor of potential constructive contributions from these elements. These considerations and the associated improvements are especially significant when the detected object has typically a large metal surface. Similar gains are possible when the tag packaging has to incorporate a thick layer of dielectric material for the purpose of weather proofing the tags for long term outdoor use.

When the reader tag combination is intended for long term use in an outdoor environment and when the objects include large metal parts prone to causing interference, the tag packages are designed so as to create constructive participation from the metal surfaces and the packaging material in the RF energy reflection and the eventual detection process. In this manner the read range of the tags are enhanced by significant amounts enabling more economical implementation of the overall system using fewer tags at the same level of performance.

An additional embodiment of the invention extends the use of reflection from metal surfaces of detected objects to identify presence of objects without any tags on them. This is accomplished by placing a tag on the assembly that holds the reader with an optimal relative placement of the two elements such that double or triple reflections involving the metal surface on the object and the tag can be reliably identified by the reader.

### DESCRIPTION OF THE FIGURES

Various embodiments of the disclosed invention will be described herein by way of example in conjunction with the following figures, wherein:

FIG. 1 is a diagram of a position tracking system for tracking the position of an object according to various embodiments of the disclosed invention;

FIG. 2 is a block diagram of the tracking device of the system of FIG. 1 according to various embodiments of the disclosed invention;

FIG. 3 illustrates various embodiments of a system for improving reading range of RFID tags

FIG. 4 illustrates various embodiments of a system for determining a location of an object with a metal surface without placing an RFID tag on the object.

### DETAILED DESCRIPTION OF THE INVENTION

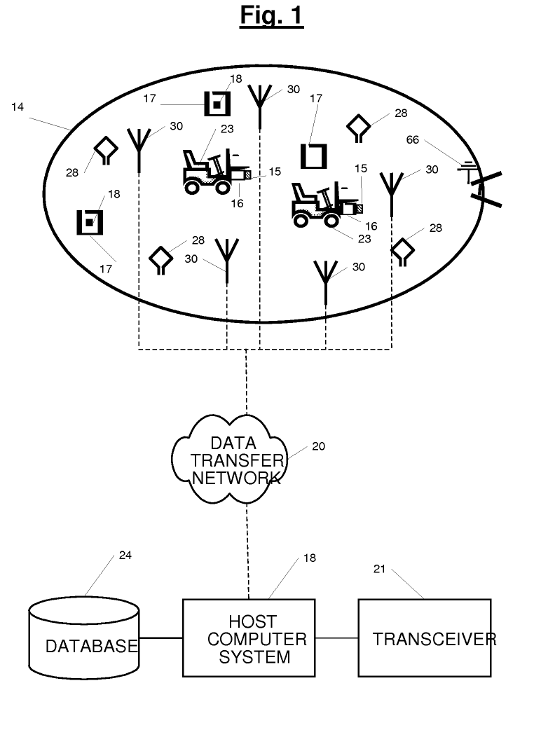

FIG. 1 is a diagram of an object identification system 10 according to various embodiments of the disclosed invention for improving the detection of one or more mobile or stationary objects in real-time (i.e., within a small response time) as the detector and the objects travel about. The tracked objects may be any tangible object that is capable of moving, whether by its own mobility system or because it is capable of being transported by other means, such as conveyor belts, vehicles, lifts, persons, etc. Accordingly, the tracked objects may be goods, containers or supports for goods, vehicles or equipment for moving goods, etc. Also, the tracked objects or goods may or may not have RF ID tags placed on them.

The identification system 10 tracks the position of the objects as they travel through areas, such as area 14, where position location information is needed. Such areas, whether indoor or outdoor, require precise location information on the order of a few meters or less for logistical purposes. Examples of such areas include manufacturing facilities, campuses, warehousing facilities, etc.

The position-identification system 10 may include, according to various embodiments, one or more tracking devices 16 which also incorporate RFID readers 15 and a host computer system 18 that communicates with the tracking devices 16. The RFID tags 18 may be attached or otherwise connected to the objects 17 to be identified and tracked, for example. In FIG. 1, two tracking devices 16₁₋₂ and RFID readers 15₁₋₂ are shown, attached to a first forklift 23₁ in area 14, and a second connected to a second forklift 23₂. It should be recognized that the tracking devices 16 and RFID readers 15 could be attached or otherwise connected to other types of vehicles, goods, containers for the goods, equipment, etc. By tracking the location of RFID tags using location tracking means in the tracking devices 16, the location of object/goods on which the tags are affixed can be effectively tracked, as long as information on which object(s) is associated with the identified RFID tags at any given time is available. Also, the tracking system 10 may track a greater number of objects than three shown in FIG. 1.

The tracking devices 16 preferably include processing capabilities that allow them to estimate their real-time position based on, for example, inertial sensor inputs and wireless signals. For example, when a tracking device 16 is in the area 14 (such as connected to forklift 23₁ or forklift 23₂), the tracking device 16 may compute its estimated position with an accuracy on the order of a few meters or less based on the input from inertial sensors and wireless signals from a wireless aiding system. The wireless aiding system may include, as shown in FIG. 1, one or more reference point transmitters 28 for providing a reference location to the tracking device 16.

The tracking device 16 may transmit RFID identifications performed by the readers 15 to the host computer 18. The tracking device 16 may also transmit its estimated position to the host computer system 18 to correlate the identified RFID tags with its position. These transmissions may be done continuously, periodically, randomly, pseudo-randomly, and/or upon a request from the host computer system 18. The host computer system 18 may maintain a centralized, real-time record of the locations of the tracked objects 17. The record can be stored in a database 24 and/or it may be a direct input to a logistic or other IT management system so that the location information can be further processed or utilized by other applications.

The host computer 18 may be implemented as one or a number of networked computers, such as servers, PCs, workstations, etc. In various embodiments, as described above, the tracking device 16 may compute its estimated position and transmit the position to the host 18, although according to other embodiments, the position determination processing may be distributed between the processing capabilities of the tracking device 16 and the host 18. Also, although only two tracking devices 16 is shown in FIG. 1, it should be recognized that at any one time the host computer system 18 may be in communication with a fewer or greater number of tracking devices. Further, the host computer system 18 may control and monitor the tracking devices 16 via control and monitoring signals sent to the tracking devices 16.

The wireless aiding system used in the area 14 may include a number of reference point transmitters 28 positioned throughout the area 14. Each reference point transmitter 28 may wirelessly transmit a high accuracy reference location position to the tracking devices 16, such as with RF, acoustic, optical, IR or other suitable signals, such that the tracking devices 16 can compute their position based on the reference as well as with input from inertial sensors, as described in referenced applications. The area 14 may also include a number of radio access points 30. The radio access points 30 may provide a wireless gateway (e.g., via the IEEE 802.11 or IEEE 802.15.4 protocols) for communications between the position tracking devices 16 and the host computer system 18. The radio access points 30 may be in communication with the host 18 via a data transfer network 20 such as, for example, a LAN, a corporate intranet, a WAN, a MAN, a TCP/IP network, a broadband computer network, a wireless communication network, or a combination of one or more of these data transfer networks.

The reference point transmitters 28 and the radio access points 30 may be strategically placed throughout the high-resolution area 14 so as to avoid interference caused by obstructions in the environment and/or co-channel interference, yet reduce the number of each that is needed to provide adequate position resolution and communications with the host 18. For example, in various applications it may be advantageous to position the reference point transmitters 28 points along or near common travel paths for the objects in the environment.

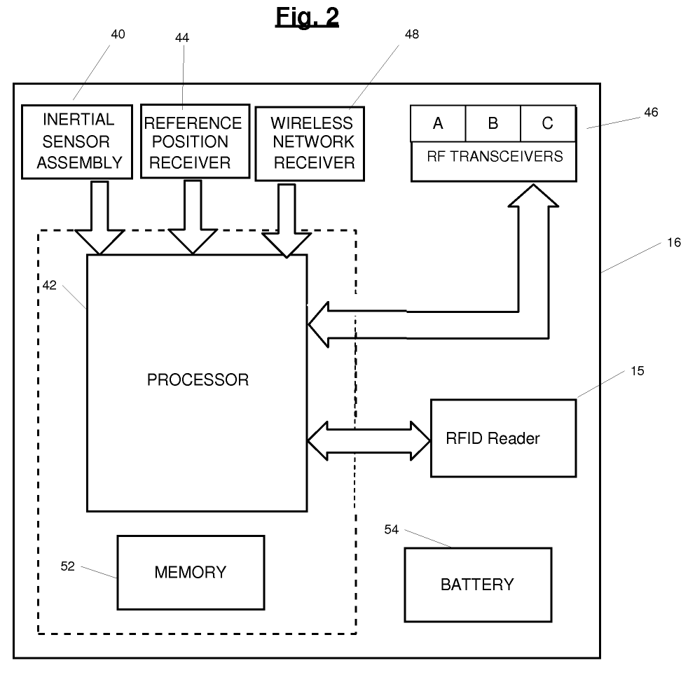

FIG. 2 is a block diagram of a tracking device 16 according to various embodiments of the disclosed invention. The tracking device 16 may compute its estimated position based on (1) inputs from a number of inertial sensors in an inertial sensor assembly 40 and (2) signals received by a reference position receiver 44 that are transmitted from the reference position transmitters 28 (shown in FIG. 1). The inertial sensor assembly 40 may detect movement by the tracking device 16, such as lateral, vertical or rotational movement, and provide corresponding data signal inputs to a processor 42. The inertial sensor assembly 40 may include a number of accelerometers (not shown) and/or gyroscopes (not shown) for detecting motion by the tracking device 16. For example, according to various embodiments, three accelerometers and three gyroscopes may be used, one for each or multiple degree(s) of freedom (x, y, z, roll, pitch, yaw) for the tracking device 16. According to other embodiments, a lesser or greater number of accelerometers and/or gyroscopes may be used. The accelerometers/gyroscopes may be, for example, micro-devices, such as MEMS-based devices. According to other embodiments, different types of inertial sensors may be used, such as optical-based inertial sensors. The processor 42 may include one or more microprocessors. For an embodiment where multiple processors are used, the tracking device 16 may employ parallel processing.

In addition to the processor 42 and the RFID receiver 15 the tracking device 16 may include, the inertial sensor assembly 40, a reference position receiver 44, and a number of RF transceivers 46A-C. The reference position receiver 44 may receive signals from the reference point transmitters 28 and forward the received reference position information to the processor 42 to aid in the position determination process. The RF transceiver 46A may communicate with the radio access points 30 and/or with other tracking devices 16. As such, the RF transceiver 46A may report object location related information such as GPS data, IMU data, RFID data and reference point data either in raw format or after post processing by the processor 42, back to the host 18 via the radio access points 30. It may also receive control and monitoring signals from the host 18 and send responses thereto.

The tracking device 16 may also include a memory device 52 and a power source, such as battery 54. The memory device 52 may be in communication with the processor 42, and store instructions and data for the processor 42. The memory device 52 may be implemented, for example, as one or more RAM units or flash memory devices, or any other suitable memory device(s). The battery 54 supplies power to the various power-consuming components of the tracking device 16.

The functions of the processor 42 may be implemented as software code to be executed by the processor 42 using any suitable computer instruction type such as, for example, Java, C, C++, Visual Basic, etc., using, for example, conventional or object-oriented techniques. The software code may be stored as a series of instructions or commands on a computer readable medium, such as a memory device 52.

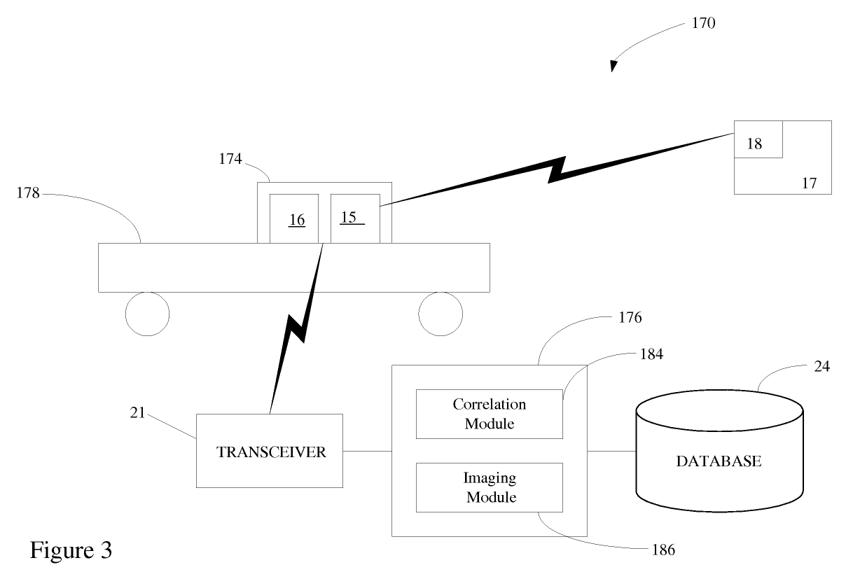

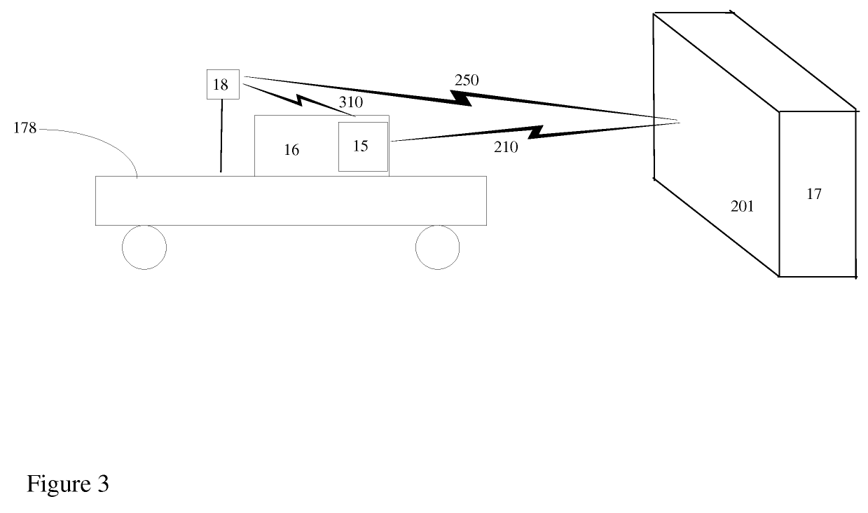

In other embodiments, the position-tracking device 16 could be mounted on, attached to, or otherwise carried by a mobile vehicle and used to determine the position of objects located throughout an environment as the mobile vehicle moves throughout the environment. FIG. 3 illustrates a system 170 according to such an embodiment for determining the location of an object 17. The system 170 may be utilized to track the respective locations of any number of objects 17, although only one such object is shown in FIG. 3 for purposes of simplicity. The system 170 includes an object location tracker 174 and a computer system 176 in wireless communication with the object location tracker 174. The object location tracker 174 is for attachment to a vehicle 178 and comprises an RFID reading device 15 and the position-tracking device 16. The vehicle 178 may be any type of vehicle capable of movement. For example, according to various embodiments, the vehicle 178 may be a pushcart such as a book cart or a shopping cart. According to other embodiments, the vehicle 178 may be a motorized vehicle such as a car, a truck, a forklift, etc. According to other embodiments, the vehicle 178 may be an autonomous robot. According to yet other embodiments, the mobile vehicle may be a person who is walking around the environment. Although only one object location tracker 174 is shown in FIG. 3, the system 170 may utilize a plurality of object location trackers 174, with each respective object location tracker 174 attached to a different vehicle 178.

The object identification reading device 15 is for sensing object identification indicia 18 on the object 17. The object identification indicia 18 may be embodied, for example, in the form of radio frequency identification (RF ID) tag on the object 17.

Although only one reading device 15 is shown attached to the vehicle 178 in FIG. 3, it should be recognized that in other embodiments the vehicle 178 may carry multiple reading devices with different coverage areas. For example, if the device 174 was being used to locate books in a library, the device 174 may have a reading device 15 for each shelf height. In such an embodiment, for example, the device 174 may include a rod with an RFID reader antenna sticking out for each shelf height.

In addition, where the environment includes a number of objects with fixed positions, the RFIDs read from those fixed-position objects by the reading device(s) 15 can be used to aid in the location determination process much like a reference position signal received from one of the reference position signal transmitters 28. In other words, if the reading device 15 reads an object with fixed known location, the position tracking device 16 can use that information to aid in the location determination process.

The position-tracking device 16 may be as described above. For example, with reference to FIG. 2, the position-tracking device 16 may include an inertial sensor assembly 40, a processor 42, a reference position receiver 44, a number of RF transceivers 46A-C, a wireless telephone network transceiver 48, a memory device 52 and a power source 54. The position-tracking device 16 may also include a processing module for computing the location of the object location tracker 174 (and hence the mobile vehicle to which the tracker 174 is attached). According to various other embodiments, the position-tracking device 16 may utilize GPS receiver for tracking it location. In other embodiments, as discussed above, the position-tracking device 16 may use a combination of a GPS receiver and the inertial sensor technique described in more detail above.

The computer system 176 is in communication with the object location tracker 174 and may be similar to the host computer 18 described hereinabove. The sensed object identification indicia and the updated location information of the object location tracker 174 are transmitted wirelessly to the computer system 176. The facility does not need to provide ubiquitous wireless communication coverage. Wireless coverage in a small area may be enough so long as the vehicle 178 passes through this coverage area at satisfactory intervals.

The computer system 176 may include a correlation module 184 for associating the sensed RFID tag 18 of the object 17, as determined by the RFID reading device 15, with a location in the environment based on the position of the object location tracker 174 in the environment, as determined by the position-tracking device 16, when the RFID reading device 15 senses the RFID tag 18.

A system 170 as described above may be used, for example, to track the location of and identify inventory in the environment. For example, the object-tracking device 170 could be attached to a book return pushcart for use in a library to track the location of books in the library that have, for example, RF ID tags that can be sensed by the RFID reading device 15. Similarly, the object-tracking device 170 could be attached to shopping cart for use in a retail store (such as a grocery store) to track the location of inventory in the store. Also, the object-tracking device 170 could be attached to a forklift or other type of industrial vehicle for use in a warehouse or transportation yard to track the location of containers, trailers or other goods. In yet another application, the object-tracking device 170 could be attached to vehicle that roams around a parking lot to track the location of cars or other vehicles in the parking lot that have, for example, RF ID tags or bar codes that can be sensed by the reading device 15.

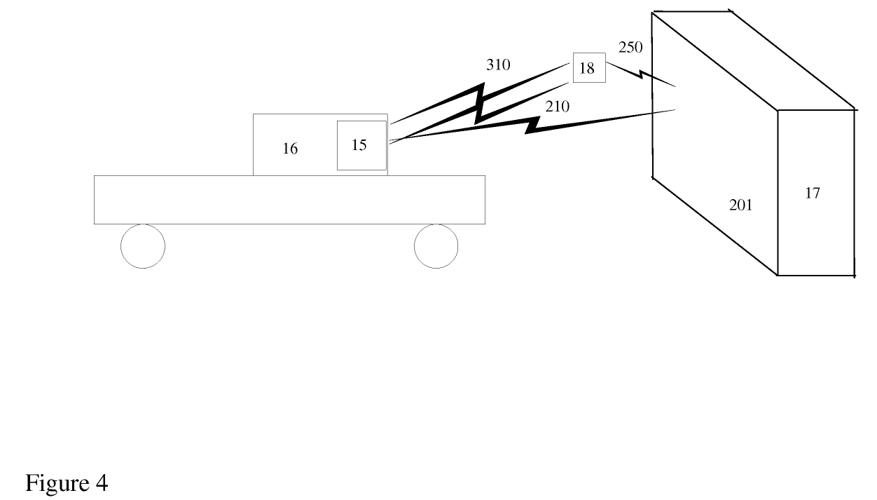

As indicated by the foregoing, reliable reading of RFID tags is an essential element of the overall functioning of the object tracking system. Referring to FIG. 4 in the case of passive tags, the reading operation is performed by transmitting RF energy 210 towards the tag 18. This RF energy excites a small amount of electrical energy in the tag circuitry. This small electrical current induced in the antenna by the incoming RF energy provides the power needed for the integrated circuit in the tag to power up and transmit a response back towards the reader. Most passive tags signal by effectively reflecting the RF energy received from the reader in this manner. The reflected RF signal is encoded with data that is stored in the tag in a non-volatile manner. In this manner, when the reader correctly receives and processes the reflected RF signal 310, it can uniquely identify the reflecting tag by means of the encoded data indicative of the data stored on the tag memory. Since the passive tags operating in this manner do not need a power supply, they can be quite small. Commercially available products exist that can be embedded in a sticker, or under the skin. As of 2006, the smallest such devices measured 0.15 mm×0.15 mm, and are thinner than a sheet of paper (7.5 micrometers).

[http://www.eetimes.com/news/design/showArticle.jhtml?articleID=179100286]. The addition of an antenna creates a tag that varies from the size of a postage stamp to the size of a post card. Passive tags have practical read distances ranging from about 4 in. (ISO 14443) up to a few meters (EPC and ISO 18000-6). The read range performance depends on the chosen radio frequency and antenna design/size.

The read range and reliability of the tag has an important influence on the feasibility, cost and the overall performance of the tracking system. For example, if the application involves tracking trailers in a trailer yard and the read range of the tag-reader combination were 4 inches, an RFID reader installed on a forklift or a yard truck can not be used to track trailers which have RFID tags placed on or in them. Conversely, for an application to track placement of items on correct places on specific shelves inside a store can not use a reader-tag combination with a range of 20 feet.

A lot of effort has been spent in trying to improve the read range of tag-reader combinations in free space through the design and placement of transmit and read antennas in the reader as well as in the tag. In this way, high performance passive tags with read ranges on the order of 100 feet have become possible. Self powered active tags can achieve even far better read ranges. These high performance solutions often come with higher price tags as well. The free space performance of a tag-reader combination provides an important baseline. The actual performance in a practical system beyond this baseline also depends on the effect of other elements in the vicinity that actively participate in electromagnetic radiation absorption and reflection. These include metals placed in the near vicinity of the tag as well as dielectrics placed in the intervening space between the reader and the tag.

Metals can have an especially complicating effect on the read range performance of the tag-reader combination. This is true even if the metal is placed behind the tag out of the direct path from the reader to the tag. This effect stems from the high conductivity of the metals which easily generate surface currents driven by the electric field of the RF wave. These currents in return generate their own electromagnetic waves radiated back into space. Due to the linear nature of the excitation, the frequencies of the original and reflected waves match. Therefore, depending on the placement of the metal surface with respect to the antenna of the tag and the wavelength of the electromagnetic radiation, the different waves can be superimposed constructively or destructively. According to one embodiment of the present invention, packaging dimensions and placement of the tags 18 with respect to the metal surfaces 201 in the environment are carefully designed to optimize the desired read range of the tags.

The following illustrate how this effect can be harnessed to advantage in practical implementation. The following table shows the read range of the combination of an Alien-9800 reader with an Alien 9440 tag as a function of the distance placed between the tag and a metal surface representative of the surface of a trailer.

TABLE 1

| Spacing between tag and | Maximum read distance between |
|---|---|
| metal surface | reader and tag |
| (inches) | (Range-in feet) |
| No metal present | 14′ |
| (reference measurement) | |
| 0 | 0 |
| 0.5″ | 10′ |
| 1″ | 18′ |
| 1.5″ | 25′ |
| 1.75″ | 26′ |
| 2″ | 26′ |
| 4″ | 26′ |

As indicated in Table 1, depending on the spacing between the tag and the metal backing, the read performance of the tag can be better or worse compared to the reference when there is no metal present in the vicinity of the tag or the reader. This effect provides a core element of this invention. By harnessing it with careful design, we are able to improve the performance of ordinary tags in use in a practical application involving metal surfaces in the goods to be tracked via RFID identification.

In an another embodiment of the present invention depicted in FIG. 5, the reflective effect of the metal surface 201 on the object 17 to be tracked is used to detect presence of such an object without placing an RFID tag on it. This idea can be motivated by the results contained in Table 1. As indicated in Table 1, the range improvement due to reflection of the energy from the metal surface persists for a long range independent of the spacing. In this long range, the reflected energy 250 from the metal backing is fulfilling its function of enhancement despite the large spacing between the metal surface and the tag independently of what the spacing value is. Consequently, it is not necessary for the tag 18 to be affixed to the metal surface 201, It is far enough separated from the metal surface in this configuration such that, it could be affixed to the same structure 178 holding the reader while still benefiting from the reflected energy 250 from the metal surface. Further element of this embodiment would place the RFID tag on the same structure 178 with the reader, behind the reader 16 in the direction the reader is probing for RFID tags. In this manner, when the reader 16 registers the presence of the RFID tag 18 that it knows is placed behind it, it can infer the presence of a metal surface 201 in front of it since without such a surface, it would not be able to register a read for the RFID tag placed behind it.

While several embodiments of the invention have been described, it should be apparent, however, that various modifications, alterations and adaptations to those embodiments may occur to persons skilled in the art with the attainment of some or all of the advantages of the invention. It is therefore intended to cover all such modifications, alterations and adaptations without departing from the scope and spirit of the present invention as defined by the appended claims.

References: 1: U.S. Pat. No. 6,094,173, Nylander Jul. 25, 2000, Method and apparatus for detecting an RFID tag signal 2. U.S. Pat. No. 6,236,315 Helms, et al. May 22, 2001 Method and apparatus for improving the interrogation range of an RF tag 3. U.S. Pat. No. 6,377,176, Lee Apr. 23, 2002 Metal compensated radio frequency identification reader 4. U.S. Pat. No. 6,590,498, Helms Jul. 8, 2003 Method and apparatus for improving the interrogation range of an RF-Tag

What is claimed is:

1. A system for improving the reading range of an RFID tag comprising:
means for estimating an optimal position with respect to elements naturally present in the environment of intended use of the RFID tag; and
means for placing the tag at or near the optimal position

2. The system of claim 1, wherein the means for estimating the optimal position include calculation of reflective contributions from metal surfaces

3. The system of claim 1, wherein the means for estimating the optimal position include measurements of reflective contributions from metal surfaces

4. The system of claim 1, wherein the means for placing the tag include use of a package holding the tag in or near optimal relative position when said package is affixed to the object being tracked

5. A method for improving the reading range of an RFID tag comprising:
means for estimating an optimal position with respect to elements naturally present in the environment of intended use of the RFID tag; and
means for placing the tag at or near the optimal position

6. The method of claim 5, wherein the means for estimating the optimal position include calculation of reflective contributions from metal surfaces

7. The method of claim 5, wherein the means for estimating the optimal position include measurements of reflective contributions from metal surfaces

8. The method of claim 5, wherein the means for placing the tag include designing of a package holding the tag that place the tag in or near optimal relative position when affixed to an object tracked using the tag

9. A system for detecting presence of objects comprising,
means for placing and RFID tag and an RFID reader in a detector assembly;
means for identifying the RFID tag in the assembly using the reader within the same assembly,
means for inferring presence of another object in the vicinity using said identification of said RFID tag

10. The system of claim 9, wherein the means for placing the RFID tag and the RFID reader include placing the RFID tag behind the reader in the direction of aiming the reader

11. The system of claim 9, wherein the means for identifying the RFID tag in the assembly using the reader within the same assembly includes benefiting from reflective contributions from metal surfaces on the object of claim 9

12. A method for detecting presence of objects comprising,
means for placing and RFID tag and an RFID reader in a detector assembly;
means for identifying the RFID tag in the assembly using the reader within the same assembly,
means for inferring presence of another object in the vicinity using said identification of the said RFID tag

13. The method of claim 12, wherein the means for placing the RFID tag and the RFID reader include placing the RFID tag behind the reader in the direction of aiming the reader

14. The method of claim 12, wherein the means for identifying the RFID tag in the assembly using the reader within the same assembly includes benefiting from reflective contributions from metal surfaces on the object of claim 12
